(19) United States
(12) Patent Application Publication
(10) Pub. No.: US 2002/0194223 A1
(43) Pub. Date: Dec. 19, 2002

(54) Computer programming language, system and method for building text analyzers

(75) Inventors: Amnon Meyers, Laguna Beach, CA (US); David Scott De Hilster, Long Beach, CA (US)

Correspondence Address: FLEHR HOHBACH TEST ALBRITTON & HERBERT LLP, Suite 3400, Four Embarcadero Center, San Francisco, CA, 94111-4187, US

(73) Assignee: Text Analysis International, Inc., Sunnyvale, CA

(21) Appl. No.: 09/981,622

(22) Filed: Oct. 16, 2001

Related U.S. Application Data
(60) Provisional application No. 60/241,099, filed on Oct. 16, 2000.

(51) Int. Cl. G06F 15/00; G06F 17/24

(52) U.S. Cl. 707/513; 707/514; 707/530

(57) ABSTRACT

Methods of building text analyzer programs using a natural language programming language that uses sets of rules and their associated code actions to form individual passes in a multi-pass text analyzer.

### BENEFIT APPLICATIONS

This application claims the benefit of the following application:

U.S. Provisional Patent Application No. 60/241,099, entitled, “Computer Programming Language, System and Method for Building Text Analyzers,” filed Oct. 16, 2001, naming Amnon Meyers and David S. de Hilster as inventors, with Attorney Docket No. P-69927 and under an obligation of assignment to Text Analysis International, Inc. of Sunnyvale, Calif.

U.S. Provisional Patent Applications No. 60/241,099 is incorporated by reference herein.

### RELATED APPLICATIONS

This application is related to the following application:

U.S. patent application Ser. No. 09/604,836, entitled, “Automated Generation of Text Analysis Systems,” filed Jun. 27, 2000, naming Amnon Meyers and David S. de Hilster as inventors, with Attorney Docket No. A-68807/AJT/JWC and assigned to Text Analysis International, Inc. of Sunnyvale, Calif.

U.S. patent application Ser. No. 09/604,836 is incorporated by reference herein.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

This invention relates to programming computers to build text analyzers. More particularly, this invention relates to the programmatic analysis of natural languages and to tools for building such computer programs.

### BACKGROUND

A text analyzer is a computer program that processes electronic text to extract information through pattern recognition. A text analysis shell is a computer program that assists in the complex task of building text analyzers. Meyers, A. and de Hilster, D., “McDonnell Douglas Electronic Systems Company: Description of the TexUS System as Used for MUC-4,”, Proceedings Fourth Message Understanding Conference (MUC-4), pp. 207-214, June 1992 (Morgan Kaufmann Publishers), describe one such shell, TexUS (Text Understanding System). TexUS features a multi-pass method of text analysis where each pass (or “step”) executes a set of rules using one of a set of predefined algorithms. TexUS also integrates a knowledge base management system (KBMS) to manage the analyzer definition, rules, dictionaries and other knowledge needed by a text analyzer. However, TexUS lacks a programming language to specify arbitrarily complex actions to take when rules and patterns are matched.

In the area of compilers for computer programming languages, YACC (Yet Another Compiler Compiler), a standard tool in UNIX operating systems, does not feature a multi-pass capability. YACC does, however, provide a method for combining a set of grammar rules with actions written in a standard computer programming language. This enables a method for specifying actions to take when rules match a text. YACC code actions enable a method for building parse trees based on the pattern matching of the rules.

YACC, however, is not well suited for building text analyzers for natural languages such as English. YACC rules and actions are compiled before use, and YACC has no Interactive interface such as a shell.

YACC enables control of data in nodes that match rule elements and in nodes that correspond to rule nonterminal symbols (“suggested” nodes). It has, however, no method for managing context information or for storing and manipulating global and local variables—other than by means of a standard compiled programming language. YACC also lacks an automated method for placing multiple variables and/or values within nodes of a parse tree. In YACC, all manipulations are programmed manually in a standard compiled programming language.

Thus, the art evinces a need for a computer programming language, system, and method that enable specifying actions to take when rules match and that apply multiple passes, when creating a text analyzer.

The art also evinces a need for an interactive method for creating a text analyzer. Still further, the art evinces a need for an interpreted language for creating a text analyzer.

These and other goals of the invention will be readily apparent to one or ordinary skill in the art on reading the background above and the description below.

### SUMMARY

An embodiment of the invention includes a text analyzer shell program that uses associated data, including a text-analyzer definition and a knowledge base (KB), to create complete text analyzer programs. The text-analyzer shell program processes the text-analyzer definition files and presents views of the analyzer definition to a user. The user modifies, enhances, executes, and tests the text analyzer using the shell program. The user may also save and run the text analyzer as a stand-alone program or as part of a larger software system.

The text-analyzer definition is written in a novel programming language of the invention, referred to herein as NLP++. In one embodiment, NLP++ uses methods of specifying text analyzers and treats each set of rules and their associated code actions as a single pass in a multi-pass text analyzer. In effect, NLP++ cascades multiple systems to support the processing of natural language text, computer program code, and other textual data. NLP++ is a full integration of a programming language and a rule language. NLP++ interleaves a code part and a rules part of the language into a pass file. NLP++ can be used as an interpreted language to accelerate the construction of text analyzers and other computer programs. NLP++ can also be compiled into optimized executable forms for faster execution or for occupying minimal space.

NLP++ uses rules, instructions in the form of code, and layout or organization of a pass file to construct text analyzers. Rules can execute selectively in contexts (for example, in particular parts of a parse tree). Code enables fine-grained control of the application, matching, and actions associated with rules. Code can be executed before, during, and after a rule match. Code conditions can be used to selectively execute or skip rules and passes. Code can be used to alter the order in which passes are executed. Code can be used to recursively nest analyzers within other analyzers. Code affects whether a rule will be executed at all. Code affects whether a rule will succeed. Code specifies the actions to be performed when a rule has matched. One set of code actions builds and modifies the parse tree for the text being analyzed. Another major set of code actions builds semantics, that is, arbitrary data structures for holding the content discovered in a text being analyzed.

Code can embellish the nodes of the parse tree itself with semantics. In an interpreted environment, the user can dynamically (“on the fly”) write new code and test it by rerunning the analyzer on the current input text. No programming language compilation and no rebuilding of the analyzer is required. Code can refer to parse tree nodes and other analysis data structures available to it. Built into the code language are specialized capabilities to reference the nodes that matched an element of the current rule, the nodes built by the rule, the context nodes dominating the nodes that matched the current rule, nodes associated with these, and global data structures for the analysis of the current input text.

Rules and code interact so that code can traverse a list of nodes merely by having a rule match every node in the list. While this “loop-free” capability is powerful, NLP++ code can also include loops, function calls and other constructs as found in standard programming languages such as C++, C, Java, and Perl.

In similar fashion, code can associate with rules to perform any number of repetitive tasks. Rules traverse and locate the nodes of the parse tree to operate on, while code performs the desired operations. In contrast, standard programming languages require explicit traversal code for a complex object such as a parse tree.

The layout of a pass file defines the machinery for executing the rules and the code for the associated analyzer pass. It defines the contexts in which rules will be applied and associates code with the rules and with the act of finding contexts in the parse tree.

These and other goals of the invention will be readily apparent to one of ordinary skill in the art on reading the Background above and the description below.

### BRIEF DESCRIPTION OF THE DRAWINGS

FIG. 1 is a block diagram of an embodiment of the invention;

FIG. 2 is a block diagram of shell-program and data components of an embodiment of the invention;

FIG. 3 illustrates a user interface for operating a shell program;

FIG. 4 illustrates a new analyzer window for creating a new text analyzer;

FIG. 5 illustrates a text-manager window for managing input texts for a text analyzer;

FIG. 6 illustrates a resume input text;

FIG. 7 illustrates a parse-tree data structure created and maintained by the invention;

FIG. 8 illustrates an analyzer-manager window for editing a sequence of passes in a text analyzer;

FIG. 9 illustrates a pass-properties window for defining one pass in a text analyzer sequence;

FIG. 10 illustrates the addition of a pass and its rule file to a text analyzer sequence;

FIG. 11 illustrates a pass file written for the third pass of the text analyzer;

FIG. 12 illustrates a parse-tree data structure modified by a third pass of a text-analyzer sequence;

FIG. 13 illustrates the pass file for the third pass modified with NLP++ code;

FIG. 14 illustrates the fourth pass and pass file of the text analyzer sequence; and

FIG. 15 illustrates a pass file that specifies and operates on a particular context in a parse-tree data structure.

### DESCRIPTION OF THE INVENTION

FIG. 1 is a block diagram of the hardware typically used in an embodiment of the invention. The computer 100 may have a conventional design, incorporating a processor 102 with a CPU and supporting integrated circuitry. Memory 104 stores computer programs executed by the processor 102, such as the shell computer program 106. The computer 100 also includes a keyboard 108, a pointing device 110 and a monitor 112, which allow a user to interact with the program 106 during its execution. Mass storage devices such as the disk drive 114 and CD ROM 116 may also be incorporated into the computer 100 to provide storage for the shell 106 and associated files. The computer 100 may communicate with other computers via the modem 118 and the telephone line 120 to allow remote operation of the shell 106 or to use remote files. Other media such as a direct connection or high speed data line may replace, supplement or complement the modem 118 and telephone line 120. A communications bus 122 may operatively connect the components described above.

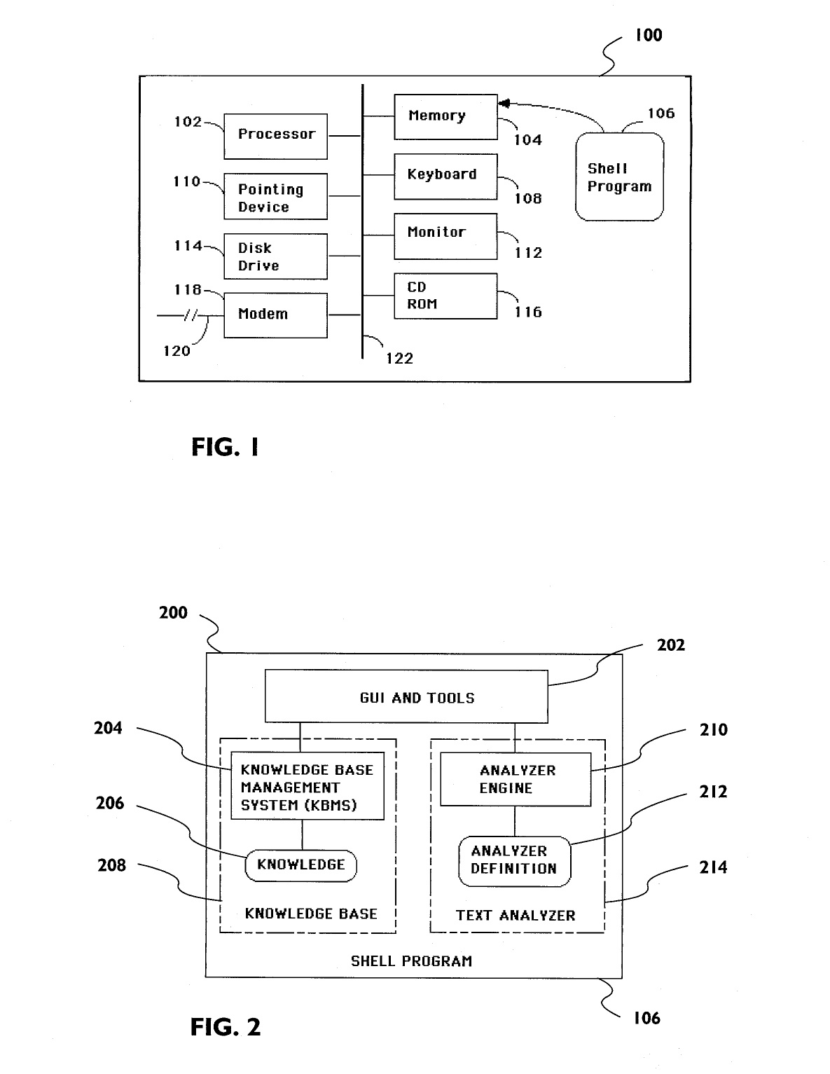

FIG. 2 provides an overview of shell 106. The shell 106 may include a user interface, preferably a graphical user interface (GUI), with a set of tools 202 for constructing a text analyzer 214. The text analyzer 214 may include a generic analyzer engine 210 that executes the analyzer definition 212 constructed by the user of the shell 106. The text analyzer 214 uses linguistic and task knowledge stored in a knowledge base 208 and may also update the knowledge base 208 with information extracted from text. The knowledge base 208 may include a static knowledge base management system (KBMS) 204 combined with knowledge 206 that may be accessed and updated analogously to a database.

The shell 106 assists the user in developing a text-analyzer program. The user may invoke the shell 106 and any of a set of tools 202 to create an initial text analyzer. The user may then extend, run or test the text analyzer under construction. The user may manually add passes to the text analyzer and write and edit natural-language-processing rules and code for each pass under construction. (NLP++, a programming language for processing a natural language, is described below.)

The text analyzer under construction may include multiple passes that the user may build one at a time using the shell 106. Each pass may have an associated pass file (also called a “rule file”) written in the NLP++ computer programming language of the invention.

A “pass” is one step of a multi-step text analyzer. In the pass, an associated algorithm may traverse a parse tree to execute a set of rules associated with the pass. (A pass may, however, consist of code with no rules.)

Herein, a “parse tree” is a tree data structure the text analyzer constructs to organize the text and the patterns recognized within the text. Successive passes of the text analyzer may operate on the same parse tree, each pass modifying the parse tree according to its algorithm and rules and handing the parse tree to the next pass.

Building and using a single parse tree avoids the combinatorial- explosion problems of recursive grammar systems and leads to efficient and fast text analyzers. Parse trees may still carry information about ambiguous language constructs (for example, polysemous words) within the parse-tree semantic structures. The single-parse-tree restriction also leads to a “best-first” text-analyzer construction methodology, where the most confident actions are undertaken first. This then provides context to raise the confidence of subsequent actions of the text analyzer.

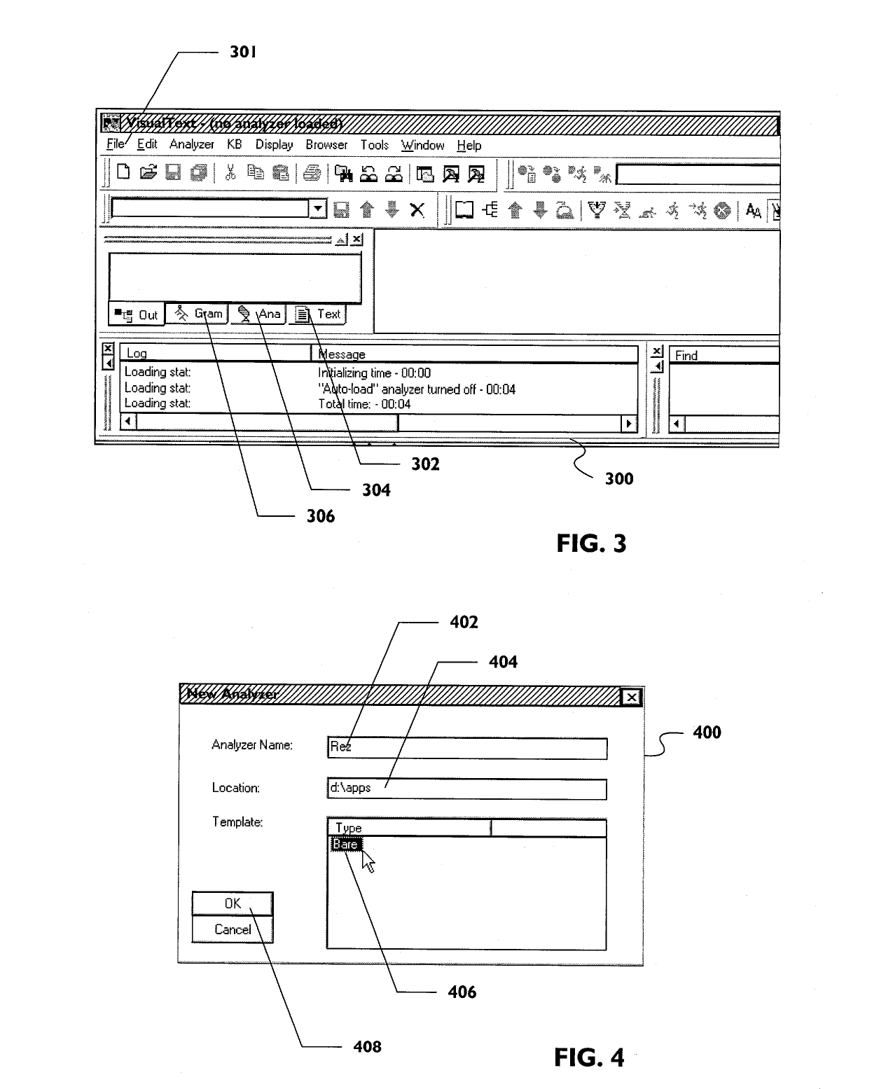

An exemplary construction of a simple text analyzer that processes an employment resume follows: When the shell 106 is invoked, a window 300 (FIG. 3) displayed to a user allows interaction with the shell 106. From the File menu (accessible by means of the File option on the menu bar of the window 300), a user may select New to bring up a window 400 (FIG. 4). The user specifies a name for the analyzer—“Rez,” for “Resume Analyzer,” for example—and the PC folder 404—“d:\apps,” for example—in which to place the text-analyzer programs and data files. The template type 406 Bare may be selected to start with a minimal analyzer. Clicking on the OK button 408 may cause the shell 106 to create an initial text analyzer.

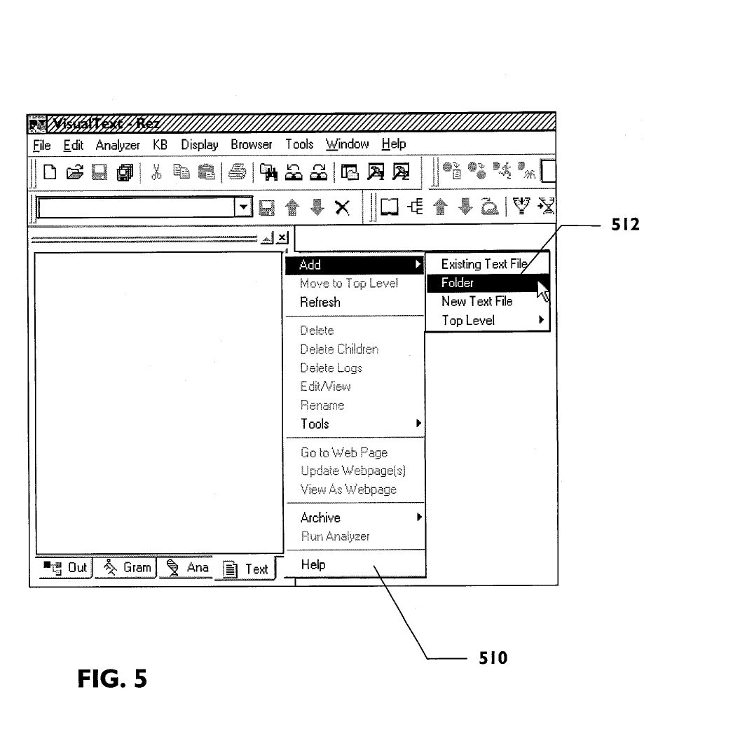

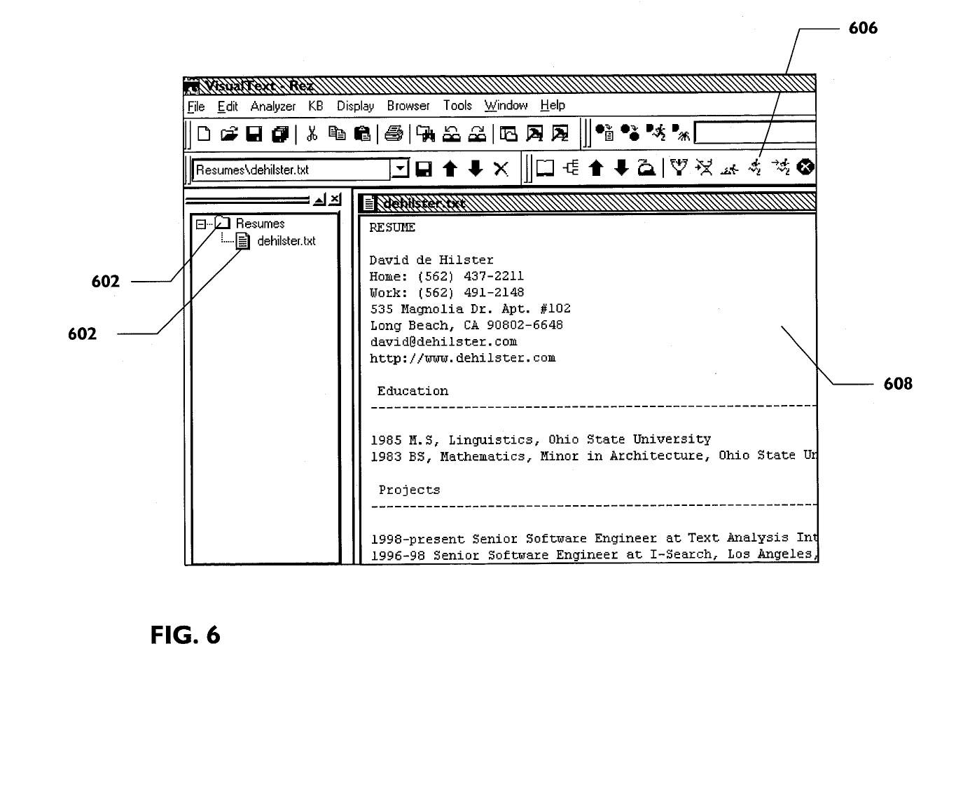

To execute the text analyzer under construction and examine the operation of individual passes, the user may select a sample resume file to serve as input to the text analyzer. In the shell window 300, the user may first select the text tab 302 to access the text manager tool. The user may then click the right mouse button in the text manager area to bring up a popup menu from which the user may select Add and then Folder, as shown in the pop up menus 510, 512 of FIG. 5. This may bring up a popup window in which the user may type “Resumes” as the name of the folder, creating folder 602 (FIG. 6). Clicking the right mouse button on the folder and selecting Add existing text file, the user may then browse to and select an existing resume file (“dehilster.txt,” for example) which may then be copied to the “Resumes” folder, creating a text file 604. A right-hand pane 608 may illustrate a portion of the input resume text.

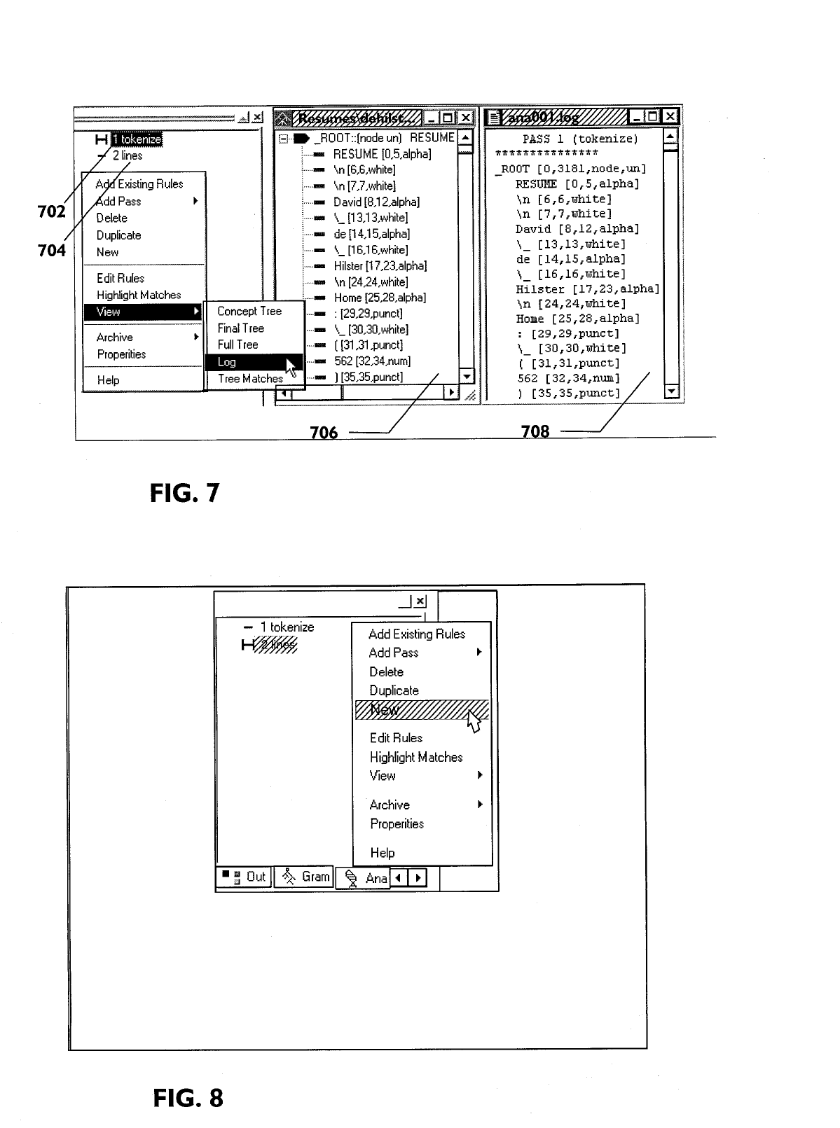

To run the initial text analyzer, the user may click the “Run” icon 606. This may cause the text analyzer to process the resume text 608. The user may click on Ana tab 304 (i.e., “Analyzer”) to view the two passes of the initial text analyzer. A tokenize pass 702 (FIG. 7) may convert characters in the resume text 608 into an initial parse tree 706, wherein each word (or token) may occupy one line and where the entire sequence of tokens may be placed directly under a root node labeled _ROOT. (An underscore ‘_’ before a name may indicate a non-literal (i.e., non-token) node of the parse tree. A backslash-n (“\n”) may indicate a newline character, while backslash-underscore (“\_”) may be a visible representation of a blank space character.)

The lines pass 704 may be the second pass of the initial analyzer. This pass may gather information about the parse tree without visibly modifying the parse tree display.

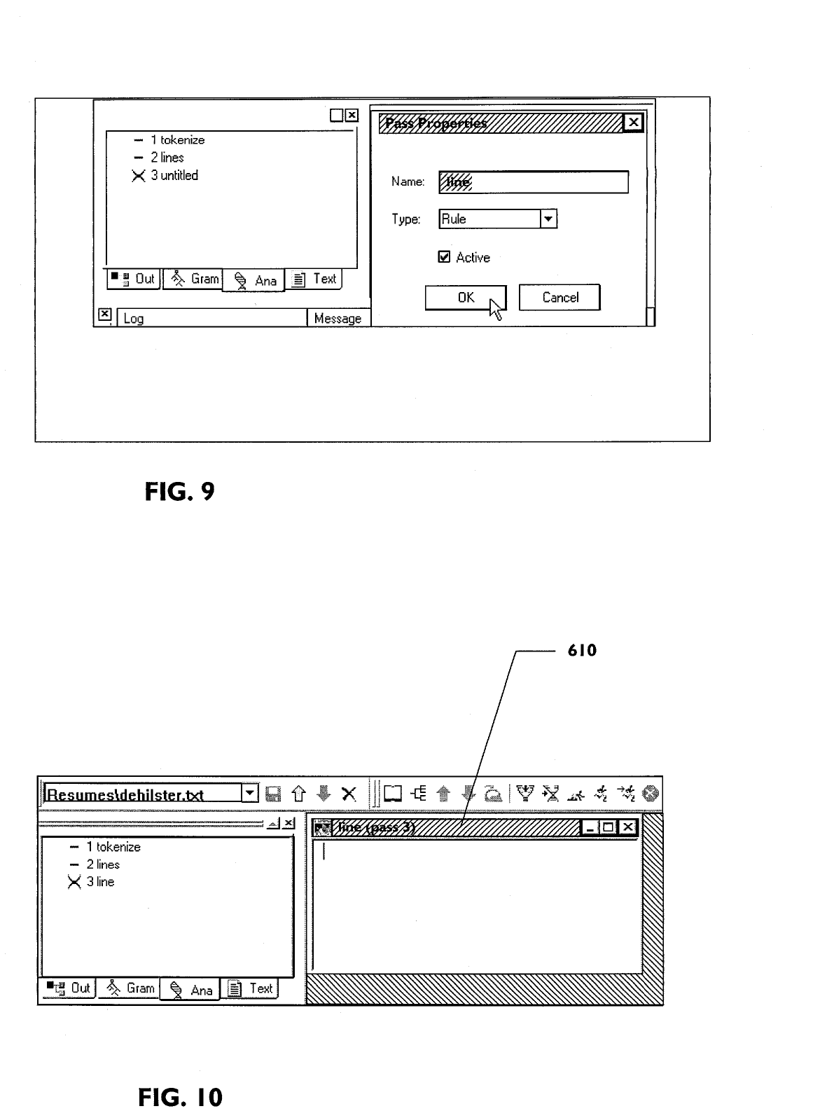

A pass may then be added with an associated pass file to the text analyzer. With the Ana tab selected as shown in FIG. 8, the user may click on the lines pass, then may click the right mouse button to bring up the analyzer menu from which the user may select New. FIG. 9 illustrates that a new pass labeled “untitled” may appear, with a corresponding Pass Properties popup window that the user may fill in. The user may name the new pass (“line,” for example) and specify the pass type (or algorithm) (“Rule,” for example). The user may then click an OK button. FIG. 10 illustrates that the new pass may now be labeled “line.”

When the user double-clicks on the “line” pass, an empty pass file window may appear in a pane 610 (FIG. 11). The empty pass file may be edited to add constructs and produce a file as shown in FIG. 11.

Some concepts are summarily defined here. The full description of the invention provides a fuller definition: A “construct” is a syntactic component of a programming language, such as a token, marker, expression, etc. As used herein, “@NODES” is an example of a marker construct.

An “element” is a token, wildcard, or nonliteral that matches one or more nodes in a parse tree. A “phrase” is a sequence of elements.

A “context” is defined by the path of nodes from the root of a parse tree down to the node of interest. A “context node” is a node within which a pass algorithm attempts to match rules. For example, if node X has children A, B, and C and the pass algorithm identifies X as a context node, then the algorithm attempts to match the pass' rules against the nodes A, B and C.

A “region” is a section of a pass file, the section delimited by markers such as @RULES and @@RULES. The rules within such a region constitute a “region of rules.”

The basics of the NLP++ syntax according to one embodiment are described: The @ (at-sign character) marks the start or end of an NLP++ construct. @NODES_ROOT directs the algorithm for the current pass to search for nodes labeled “_ROOT” and attempt to match rules in the pass file only in the phrase of nodes immediately under such nodes labeled “_ROOT.” Such found (“selected”) nodes are context nodes for the current pass.

@RULES specifies that a region of rules is to follow in subsequent lines of the pass file. A rule has the general form

X←A B C . . . @@

where the phrase of elements A, B, C, etc. to the right of the arrow (“←”) is the pattern to be matched against a sequence of nodes in the parse tree, the @@ marker terminates the rule, and the distinguished element X is the suggested element of the rule. Typically, when the phrase of elements matches a sequence of nodes, that sequence is gathered under a new node in the parse tree labeled, “X.” The sequence of nodes is reduced to node X (the phrase of elements is reduced to X).

Each element X, A, B, C, etc. of the rule may be followed by a descriptor enclosed in square brackets ([ ]), where the user may specify further information about matching that element. The first rule

_BLANKLINE←_xWILD [matches=(\\r \t )]\n @@

states that a blank line is suggested by a phrase of two elements. The first element is _xWILD, a special nonliteral called a “wildcard” and described further below. The second element is a newline character. A wildcard typically matches any node it encounters, but the descriptor for the wildcard in this rule specifies that the wildcard must match one of a blank-space character (“\”), carriage-return character (“\r”), or tab character (“\t”). Thus, any number of such white-space characters followed by a newline matches the first rule. When such a sequence of nodes is found (under the _ROOT context node), it is reduced to a node labeled, “_BLANKLINE.”

Similarly, the second rule matches lines that have tokens other than white-space tokens. The third rule matches lines that are not terminated by a newline and thus can occur only at the end of a computer text file.

The rule-type algorithm of the current pass (named “line”) may operates as follows: It may first find a selected context node in the parse tree, then may traverse its phrase of children nodes. At the first node, it may try each rule of the pass file in turn. If a rule matches, its actions may be performed, after which the algorithm may continue at the node following the last node matched by the rule. If no rule matches, the algorithm may continue at the second node, and so on, iteratively, until the last node in the phrase of children has been traversed. At this point, the algorithm may recursively look for the next context node until all nodes have been traversed.

Once a context node has been found, the algorithm may decline to search for a context node within the subtree of that context node. Also, individual rules or code may modify the normal traversal of the algorithm—by terminating the algorithm if a special condition has been detected, for example.

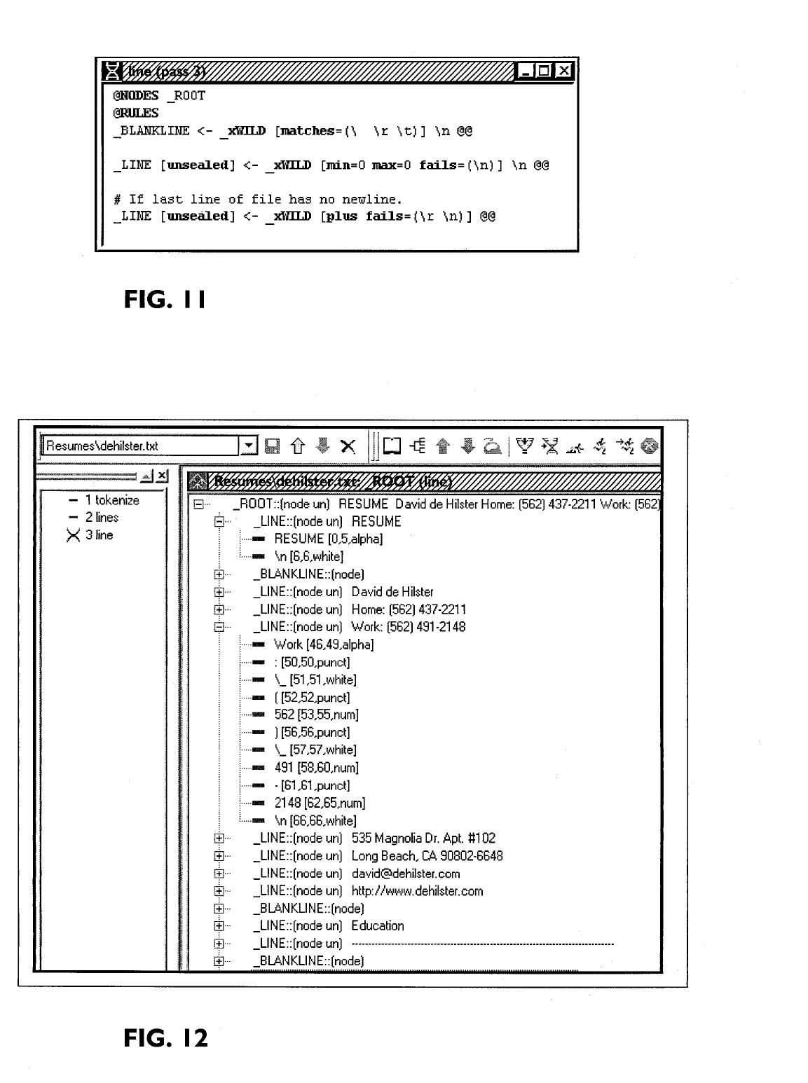

To run the text analyzer, the user may click the Run icon 606. FIG. 12 illustrates the parse tree as modified by the “line” pass. The tokens of each line have now been gathered within nodes labeled “_LINE” and “_BLANKLINE.”

After the line pass, passes may be added that process in the context of _LINE nodes, iteratively creating yet more contexts. Passes may also be added that operate on the sequence of line nodes itself, by specifying _ROOT as the context. The ability of NLP++ to selectively apply rules to particular contexts within a parse tree distinguishes NLP++ from systems such as YACC that have no such mechanism to pinpoint contexts. Applying rules in restricted contexts according to the invention reduces the amount of work an analyzer does, thereby increasing its speed and efficiency. Applying rules in restricted contexts also reduces spurious pattern matching by searching only in contexts that are relevant and appropriate.

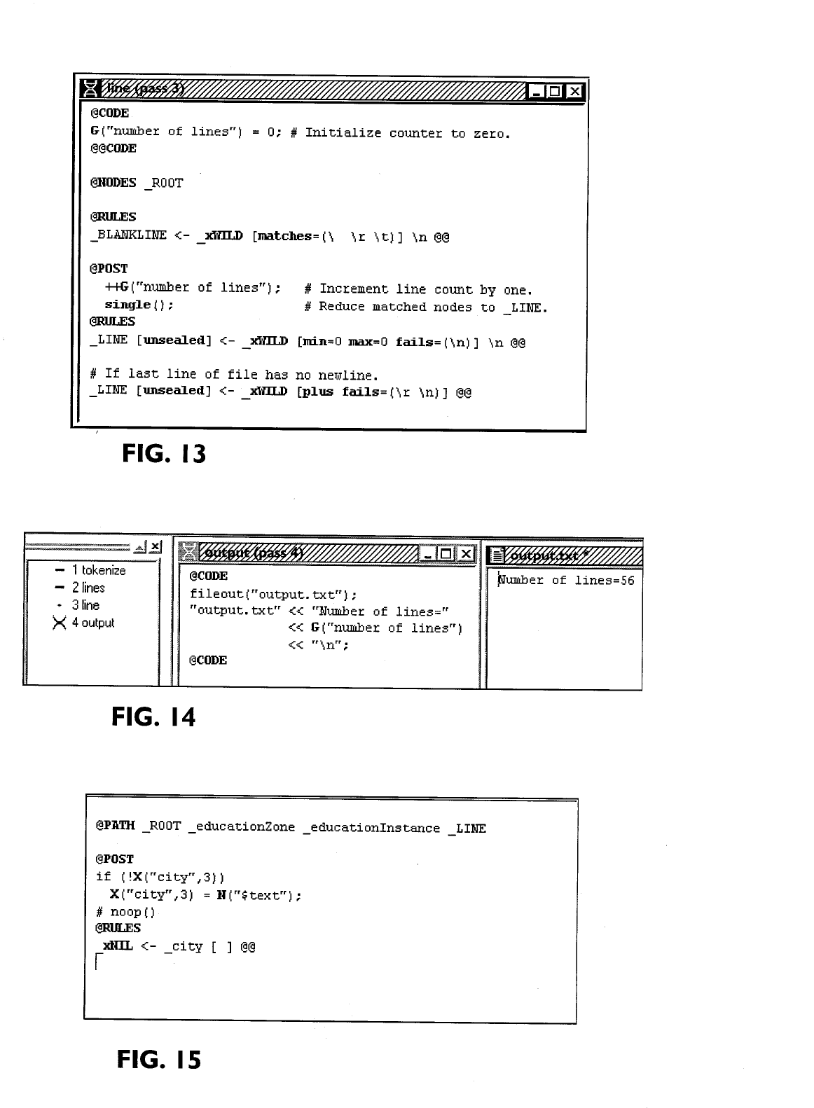

FIG. 13 illustrates an alternative line pass file. The @CODE and @@CODE markers may denote the start and end of the code region in a pass file. The code region may be executed only once, prior to matching any rules in the pass.

The internal function G( ) may manipulate global variables. The single code statement

G(“number of lines”)=0;

may assign the value 0 (zero) to a global variable “number of lines.”

(In C++-like syntax, a ‘;’ (semi-colon) character terminates a statement, and a ‘#’ (pound-sign) character introduces a comment that extends to the end of the line.)

A @POST region may direct that if any rules in the following @RULES region match nodes in a parse tree, then the code in the @POST region executes for each such matched rule. In FIG. 13, the user specifies a post region (started with the @POST marker) before the two rules for gathering non-blank lines (now in a separate @RULES region from the rule for a blank line). The first statement of the @POST region

++G(“number of lines”);

increments the value of the global variable “number of lines” whenever a rule for gathering a line has been matched.

The function single( ) may specify that the default reduce action is to execute when one of the line rules matches. When the user adds a @POST region, the default rule reduction action is superseded, and the single( ) action restores the default reduce action.

With the line pass shown in FIG. 13, the text analyzer counts the number of lines in an input text file. The analyzer, however, does not provide a way to view that count.

FIG. 14 displays an updated analyzer sequence with a new output pass file. The analyzer now includes a fourth, “output,” pass. FIG. 14 also illustrates the output text file created by this pass file when the analyzer is run again.

The code in the output pass uses the fileout( ) function to declare that output.txt is an output file and then executes an output statement analogous to a C++ output statement. The output statement prints out the value of the global variable “number of lines” to the output.txt file.

In addition to the G( ) function for manipulating global variables, NLP++ may supply an N( ) function for managing data attached to nodes that match an element of rule, an S( ) function for managing data attached to the suggested node of a rule, and an X( ) function for manipulating similar data in context nodes. These variable specifications offer more control over the management of parse-tree information than in such systems as YACC. NLP++ control of knowledge in the context surrounding rule matching extends the YACC methodology.

FIG. 15 illustrates NLP++ syntax and methods for exploring precise contexts in a text analyzer. The @PATH specifier may define a path in the parse tree, starting from the _ROOT node of the parse tree, down to an immediate child node _educationZone, then down to a node _educationInstance and then down to a _LINE node. Typically, in a job resume, a section (or “zone”) for a candidate's educational background includes sets of schools, degrees, majors, and dates, each set of which is called an “education instance” herein. Each instance may cover one or more lines of a resume. The path specifier may thus constrain rules in the current pass to be matched only within lines within each education instance. Each node in the path sequence is called a “context node.”

In this example, the only rule to be tried looks for a _city node within the specified _LINE contexts. The code in the post region specifies that if context node number 3 (counting from _ROOT) does not yet contain a variable called “city,” then the analyzer is to set that variable in that context node equal to the text obtained from a matched city node. In effect, the first node labeled _city encountered within an education instance will have its text fetched (by the $text special variable) and stored in a variable of that education instance. In this way, the city in which a school is located will be placed in its education instance node.

This example illustrates that rules can be executed in precisely specified contexts, and that information within those contexts can be updated and accessed via the X( ) function for context variables.

NLP++ may combine a programming language and a rule formalism. The rules may be a substrate for both recursive and pattern-based algorithms. A pass file (or “rule file”) may hold the rules and programming language code that execute in one pass of the multi-pass text analyzer. NLP++ may use the @ (at-sign character) to separate regions in a pass file. For example, @CODE may denote the start of the global code region. @@CODE may denote the end of the global code region. A @@ may mark the end of a rule.

Some regions may contain nested regions. A “collection” as referred to herein indicates a set of related regions, possibly with constraints on the ordering of regions. Collections may repeat.

The following is an example of a code region:

```
@CODE
  G(“nlines”) = 0;
@@CODE
@FIN
  “output.txt” << “lines=” << G(“nlines”) << “\n”;
@@FIN
```

The @CODE region may execute before rules (if any) are matched in the current pass. The @FIN region may operate after all rule-matching machinery finishes executing in the current pass. In the above example, the global variable nlines is initialized to zero. Assuming that the rules of this pass file count the number of lines in the file, then the @FIN region executes, causing the analyzer to print out something like “lines=35” to the file output.txt.

A context region such as @NODES _LINE may direct the algorithm for the current pass file to apply rules only within parse-tree nodes whose name is “LINE.” Using such a specifier, the user may strictly control the parts of a document to which particular rules apply. For example, in a resume, rules to find the applicant name typically apply only in the initial area (“contact section”) of a resume. Another context region, @PATH _ROOT _LINE, may direct the analyzer to traverse from the root of the parse tree down to nodes named “_LINE” and to apply the rules of the pass file only within those nodes.

The default may be to apply rules only to the phrase immediately below the specified context node—for example, _LINE in both of the examples above. @NODES and @PATH differ in that @NODES directs the analyzer to look anywhere within the parse tree, while @PATH fully specifies a path to the context nodes, starting at the root (_ROOT) of the parse tree.

The @MULTI specifier may direct the algorithm for the current pass to find context nodes in the same way as the @NODES specifier. Once such a node is found, it may be treated as a subtree. Rules may be recursively applied to every phrase of nodes within the subtree.

The context specifiers @NODES, @PATH, etc. may be immediately followed by @INI and @FIN code regions. The @INI region may execute as soon as a context node has been found, while the @FIN region may execute after rules have been matched for the context node. These specifiers allow the user flexibility in engineering the actions of the analyzer.

Rule regions may be enclosed between named regions as follows:

@RECURSE name
#Rule collections in here
@@RECURSE name

These named regions may be “mini-passes” within a single pass file. When a rule in the main rule collections matches, individual elements of the rule may invoke these recursive regions to perform further processing on the nodes that matched the invoking rule elements.

A rule collection may include the @COND, @PRE, @POST, and @RULES regions. Each collection may contain at least a @RULES marker, and the order of regions may be as given above. NLP++ code may be in all these regions except @RULES, which may contain a list of NLP++ rules. The @COND, @PRE, and @POST regions may apply to each rule in the @RULES region. To start a new rule collection, one may define a subsequent set of these regions containing at least a @RULES marker.

NLP++ code in a conditional tests region (herein a “cond region” or “@COND region”) may determine whether the subsequent @RULES region is attempted at all. “Cond” stands for “conditional” tests. Typical conditions are code that checks variables in context nodes and in the global state of the text analyzer. For example, if the current resume-analyzer pass identifies an education zone, but the education zone has already been determined by prior passes, then a @COND region may direct the analyzer to skip the current pass.

NLP++ code in the @PRE region may constrain the matching of individual rule elements. For example:

<1,1> cap( );

may direct that, after the first rule element has matched, it must satisfy the additional constraint of being a capitalized word.

NLP++ code in the @POST region may execute after a rule match. It may negate the rule match but typically builds semantic information and updates the parse tree to represent matched rules.

Since a rule match represents success in finding something in the parse tree, the @POST region is the typical region that modifies nodes in the parse tree and embellishes them with attributes.

NLP++ rules may reside in rules region. An NLP++ rule may have the following syntax:

SuggestedConcept←element element . . . @@

The arrow “←” separates the phrase of elements to be matched to the right of the arrow from the name of the suggested concept to the left of the arrow. The @@ marker terminates the rule.

A typical application of such a rule attempts to match the elements of the phrase to a list of nodes in the parse tree. On success, the matched nodes in the parse tree typically are excised and a new node labeled with the name of the suggested concept entered in their place. The excised nodes are placed under this new node.

The general syntax for an element is:

atom [key=value key=value . . . ]

The atom may be a literal token—the word “the” or a character such as ‘<’ denoted by the escape sequence “\<”, for example. The atom may be a non-literal, designated with an initial underscore. For example, “_noun” may denote the noun part of speech, whereas “noun” without the underscore denotes the literal word “noun.” The atom may also be one of a set of special (“reserved”) names. _xWILD for wildcard matching and _xCAP to match a capitalized word are examples.

An element or a suggested concept may have a descriptor, a list of “key=value” pairs within square brackets. If present, the list specifies further information and constraints on the matching of the element.

Table I describes special elements that may be used in NLP++ rules. Some of these elements match text constructs and conditions useful to text analysis.

TABLE I
Exemplary NLP++ Special Elements

| ELEMENT ATOM | DESCRIPTION |
|---|---|
| _xWILD | Unrestricted wildcard. Key-value pairs may add |
| | restrictions on number of nodes matched and on |
| | what is matched. With a match or fail list, _xWILD |
| | becomes an “OR” matching function. |
| _xANY | Matches any single node. |
| _xNIL | Designates a suggested element when the rule per- |
| | forms a special action, such as removing the |
| | matched nodes from the parse tree. _xNIL has no |
| | special action and serves as documentation for |
| | the rule writer. |
| _ALPHA | Matches an alphabetic token, including accented and |
| | other extended ANSI chars. |
| _xCTRL | Matches control and non-alphabetic extended |
| | ANSI characters. (Compare_xALPHA.) |
| _xNUM | Matches a numeric token. |
| _xPUNCT | Matches a punctuation token. |
| _xWHITE | Matches a white-space token, including newline. |
| _xBLANK | Matches a white-space token, excluding newline. |
| | Equivalent to _xWILD [match = (\\t)]. |
| _xCAP | Matches an alphabetic with an uppercase first letter. |
| _xEOF | Matches the end of file. |
| _xSTART | Matches if at the start of a phrase (or “segment”). |
| _xEND | Matches if at the end of a phrase (or “segment”). |

For example:

_xWILD [match=(hello goodbye)]

specifies an element _xWILD, which matches any node in the parse-tree data structure. However, the descriptor constrains the wildcard to match only a parse-tree node labeled, “hello,” or a node labeled, “goodbye.”

Table II describes the match and other keys, detailing any value associated with each key:

TABLE II
Exemplary Key and Value Descriptions

ATOM

| KEY | VALUE | DESCRIPTION |
|---|---|---|
| trigger | (NONE) | Match the current element first. For example: |
| trig | | _np <− _det_quan_adj_{—noun [t] @@} |
| t | | |
| min | NUM | Match a minimum of NUM nodes. 0 means the current |
| | | element is optional. For example: |
| | | _boys <− the [min = 0 max = 1] boys @@ |
| max | NUM | Match a maximum of NUM nodes. 0 means the current |
| | | element can match an indefinite number of nodes. |
| | | For example: |
| | | _htmltag <− \<_xWILD [min = 1 max = 100]\> @@ |
| optional | (NONE) | Optional element. Match a minimum of 0 and a |
| option | | maximum of 1 node. Short for min = 0 max = 1. For |
| opt | | example: |
| o | | _vgroup <− _modal [opt]_have [opt]_be [opt]_{—} |
| | | verb @@ |
| one | (NONE) | Match exactly one node. Short for min = 1 max = 1. |
| star | (NONE) | Indefinite repetition. Match a minimum of 0 up to any |
| | | number of nodes. Short for min = 1 max = 0. |
| plus | (NONE) | Indefinite repetition. Match a minimum of 1 up to any |
| | | number of nodes. Short for min = 1 max = 0. |
| rename | NAME | Rename every node that matched the current |
| ren | | element to NAME. For example: |
| | | locfield <− location \:_xWILD [ren = location]\n @@ |
| singlet | (NONE) | Search a node's descendants for a match. Stop |
| s | | looking down when a node has more than one child or |
| | | has the BASE attribute set. For example: |
| | | _abbr <− _unk\. [S] @@ |
| Tree | (NONE) | Search node's entire subtree for a match. (Overuse of |
| | | this key may degrade analyzer performance.) |
| matches | LIST | For the _xWILD element only. Restricted wildcard |
| match | | succeeds only if one of the list names matches a node. |
| | | For example: |
| | | _james <− _xWILD [match = (jim jimmy james) singlet |
| | | min = 1 max = 1] @@ |
| fails | LIST | For the _xANY element only. Match fails if node |
| fail | | matches anything on the list. For example: |
| | | _par <− _xWILD [fail = (_endofpar_par) min = |
| | | 1 max = 0] @@ |
| excepts | LIST | For the _xANY element only. Must be accompanied by a |
| except | | single match or fail list. Matching an item on the except list |
| | | negates the effect of a match on the match or fail list. |
| lookahead | (NONE) | Designates the first lookahead element of a rule. The |
| | | first node matching the lookahead element or to the |
| | | right of it becomes the locus where the pattern |
| | | matcher continues matching. |
| layers | LIST | Layer additional attributes for the element in the parse |
| layer | | tree as “mini-reductions.” Use the names in the list to |
| | | name nodes. Each node that matched current rule |
| | | element is layered. |
| recurse | LIST | Invoke a recursive rules pass on nodes that matched |
| | | the current rule element. For example: |
| | | _tag <− \<_xWILD [recurse = (tagrules)]\> @@. |

The suggested element (or concept) of a rule has a separate set of keys and values in its descriptor, as detailed in Table III. The suggested element of a rule builds a new node in the parse-tree data structure to represent the matched rule.

TABLE III
Exemplary Suggested Element of Rule and Associated Keys and
Values

| | | |
|---|---|---|
| base | (NONE) | The suggested node is the bottom-most node to |
| | | search when looking down the parse tree for a match |
| | | (see singlet above). |
| unsealed | (NONE) | The suggested node will be searched for select nodes |
| | | (i.e., nodes specified by @NODES). |
| layers | LIST | After normal reduce, perform additional reduces, |
| layer | | naming the nodes as in the list. This enables layering of |
| attrs | | attributes in the parse tree. |
| attr | | |

Four classes of NLP++ variables in one embodiment are summarized in Table IV:

TABLE IV
Classes of NLP++ variables.

| VARIABLE | DESCRIPTION |
|---|---|
| G(varname) | Global variable. |
| S(varname) | Variable belonging to the suggested concept of a |
| | rule. |
| X(varname, num) | Variable belonging to the num-th context node |
| X(varname) | starting at the root of the parse tree. Usually refers to |
| | the num-th node of the @PATH select list. |
| | With @NODES, the preferred form is X(varname). |
| N(varname, num) | Variable belonging to a node that matched the num- |
| N(varname) | th element of a rule phrase. |

The special variable names detailed in Table V provide information about parse-tree nodes, text and other state information during the text analysis of an input text. For example:

N(“$text”, 1)

fetches the text string associated with a parse-tree node that matched the first element of the current rule.

TABLE V
Exemplary Special Variable Names
VARIABLE

| NAME | FUNCTIONS | DESCRIPTION |
|---|---|---|
| $text | N, X | Fetch the text covered by the node. Cleanup |
| | | white spaces (for example, removing leading and |
| | | trailing white spaces and converting separators to a |
| | | single space). (Uses the original text buffer, rather |
| | | than the subtree under the node, in order to |
| | | gather text.) |
| $raw | N, X | Fetch the text covered by the node. (Uses the |
| | | original text buffer, rather than the subtree under |
| | | the node, in order to gather text.) |
| $xmltext | N, X | Same as $raw, but converts characters that are |
| | | special to HTML and XML. For example, ‘<’ is |
| | | converted to “&It;”. |
| $length | N, X | Get the length of node's text. |
| $ostart | N, X | Start offset of the referenced node in the input |
| | | text. |
| $oend | N, X | End offset of the referenced node in the input text. |
| $start | N, X | Evaluates to 1 if the referenced node has no left |
| | | sibling in the parse tree, otherwise to 0. |
| $end | N, X | Evaluates to 1 if the referenced node has no right |
| | | sibling in the parse tree, otherwise to 0. |
| $input | G | Get fully qualified input filename, for example: |
| | | “D:\apps\Resume\input\Dev1\rez.txt” |
| $inputpath | G | Get fully qualified input file path, for example: |
| | | “D:\apps\Resume\input\Dev1” |
| $inputname | G | Get input filename, for example: “rez.txt” |
| $inputhead | G | Get input file head, for example: “rez” |
| $inputtail | G | Get input file tail (“extension”), for example: “txt” |
| $allcaps | N | Returns 1 if the token underlying the node is all |
| $uppercase | | uppercase. Otherwise returns 0. If multiple words |
| | | (even if all are all-caps), returns 0. |
| $lowercase | N | Returns 1 if the token uderlying the node is all |
| $cap | N | Returns 1 if the token underlying the node is a |
| | | capitalized word. Otherwise returns 0. |
| $mixcap | N | Returns 1 if the token underlying the node is a |
| | | mixed-capitalized word. Otherwise returns 0. |
| | | Examples of mixed-capitalized words are |
| | | “Michigan” and “abcD.” |
| $unknown | N | Returns 1 if the token underlying the node is an |
| | | unknown word. Otherwise returns 0. Requires a |
| | | lookup() code action prior to any use of this |
| | | special variable. |

The operators in NLP++ expressions, shown in the following table, may be analogous to those in the C++ programming language. However, the differences may be as follows: The plus operator, +, if given string arguments, automatically performs string catenation.

The confidence operator, %%, is unknown in any prior-art text analyzers. The operator combines confidence values while never exceeding 100% confidence. For example,

80%%90

conjoins evidence at 80% confidence with evidence at a 90% confidence level, yielding a confidence value greater than 90% and less than 100%. The confidence operator may be used, for example, to accumulate evidence for competing hypotheses.

TABLE VI
Exemplary NLP++ Operators

| OPERATOR | DESCRIPTION | ASSOCIATIVITY |
|---|---|---|
| + + | Post increment, decrement | Left to right |
| − − | | |
| + + | Pre increment, decrement | Right to left |
| − − | | |
| + + | Pre increment, decrement | Right to left |
| − − | | |
| ! | Logical NOT (unary) | Right to left |
| + − | Unary plus, minus | Right to left |
| % | Remainder | Left to right |
| * | multiplication | |
| / | division | |
| % % | confidence | |
| + | Addition, subtraction | Left to right |
| − | | |
| < | Relational operators | Left to right |
| > | | |
| < = | | |
| = = | | |
| ! = | | |
| > = | | |
| & & | Logical AND, OR | Left to right |
| \| \| | | |
| = | Assignment | Right to left (multiple |
| | | assignment works) |
| * = | Shorthand assignment | Right to left |
| / = | | |
| + = | | |
| − = | | |
| % % = | | |
| < < | Output operator | Left to right |

While the user may define NLP++ functions, the shell may include pre-built and special functions (“actions”) to assist in the development of a text analyzer. Variable actions (Table VII), print actions (Table VIII), pre actions (Table IX), post actions (Table X) and post actions for printing information (Table XI) are capabilities that may be included in the shell.

The pre actions in Table IX are useful capabilities in the @PRE region of a pass file. A pre action may further constrain the match of each rule element to which it applies.

Post actions are typically associated with the @POST region of a pass file. The @POST region is executed once a rule match has been accepted. Actions may include the modification of the parse tree and the printing out of information. Of course, NLP++ code may be added to this and any other code region to perform other actions as well.

TABLE VII
Variable Actions

| ACTION | DESCRIPTION |
|---|---|
| var(varname, str) | Create global variable with name varname and |
| | initial value str. If str2 is all numeric, then the code |
| | action inc() can increment the value of the |
| | variable. (This implements a counting variable. The |
| | NLP++ method is preferable.) |
| varstrs(varname) | Create an empty multi-string-valued global vari- |
| | able with name varname. The post action addstrs() |
| | adds values to this type of variable. |
| sortvals(varname) | Sort the strings in multi-string-valued global vari- |
| | able varname. |
| gtolower(varname) | Convert the strings in multi-string valued global |
| | variable to lower case. |
| guniq(varname) | Remove redundancies in a sorted, multi-string |
| | valued global variable. |
| lookup(var, file, | Specialized word lookup. Global variable var has |
| flag) | multiple words as values, file is a file of strings, one |
| | per line.flag tells which bit-flag of the word's |
| | symbol table entry to modify. For example, lookup |
| | (“Words,” “dict.words,” “word”) looks up all the |
| | values in the Words variable in the dict.words |
| | file and modifies the word bit-flag |
| | (which says whether the word is a proper |
| | English word). |

TABLE VIII
Print Actions

| ACTION | DESCRIPTION |
|---|---|
| print(str) | Print the literal string str to the standard output. |
| printvar(var) | Print the values of the global variable var to standard |
| | output. |
| fprintvar(file, var) | Print the values of the global variable var to the file |
| | named file. |
| prlit(file, str) | Print the literal string str to the file named file. |
| Gdump(filename) | Dump all global variables and their values to the |
| | given filename. |
| fileout(file) | Open the specified file for appending. The specified |
| | file becomes a variable useable in print actions with a |
| | file argument - prlit(), for example. |
| startout(0) | Divert standard output (from, typically, the con- |
| | sole or a DOS window) to the main output file. |
| | Called by the caller of the analyzer. A default output |
| | file may apply. |
| stopout(0) | Stop diverting standard output to the main output file. |
| | Subsequent file-less output is to standard output. |

TABLE IX
Pre Actions

| ACTION | DESCRIPTION |
|---|---|
| uppercase() | Succeed if the leaf token is all uppercase. |
| lowercase() | Succeed if the leaf token is all lowercase. |
| cap() | Succeed if the leaf token has its first letter |
| | capitalized. |
| length(num) | Succeed if the leaf token length equals num. |
| lengthr(num1, num2) | Succeed if the leaf token length is in the inclu- |
| | sive range (num1, num2). |
| numrange(num1, num2) | Succeed if the leaf token is numeric and in the |
| | inclusive, given range. |
| unknown() | Succeed if the leaf token is an unknown word. |
| | Meaningful only if a prior pass has performed a |
| | lookup() code action. |
| debug() | Succeed unconditionally. Places a C++ break- |
| | point at a particular rule. |

TABLE X
Post Actions

| ACTION | DESCRIPTION |
|---|---|
| single() | Single-tier reduce. Reduce the entire set of |
| | nodes that matched a rule phrase. |
| singler(num1, num2) | Single-tier reduce of a range of rule elements. |
| | For example, if finding a period is an end-of- |
| | sentence in a context, the goal is to reduce |
| | the period to end-of-sentence, not the whole |
| | context. |
| singlex(num1, num2) | Single-tier reduce of a range of rule el- |
| | ements, with all nodes not in the range excised. |
| | For example, if matching a keyword html tag, |
| | the goal is to reduce the keywords and to |
| | remove the rest of the tag. |
| merge() | Single-tier reduce that dissolves each top- |
| | level node in the matched phrase. |
| merger(num1, num2) | Single-tier reduce that dissolves each top- |
| | level node in the matched range. |
| listadd(olist, oitem) | Add a new node to a list node's children. If |
| listadd(olist, oitem, keep) | the item occurs after the list (olist < oitem), it |
| | is added as the last child. If the item occurs |
| | before the list, it is added as the first child. The |
| | optional keep argument may be “true” or |
| | “false”. If “true,” it keeps the nodes between |
| | the list and the item as children of list. If |
| | “false,” it excises all the intervening nodes. |
| excise(num1, num2) | Excise the nodes matching the range of |
| | elements from the parse tree. |
| splice(num1, num2) | Dissolve the top level nodes of given range. |
| xrename(name, num) | Rename the num-th context node to name. |
| xrename(name) | If the num argument is absent or 0, rename |
| | the last context node. |
| setbase(num, bool) | Set the BASE attribute of the num-th node to |
| | “true” or “false.” |
| setunsealed(num, bool) | Set the UNSEALED attribute of the num-th |
| | node to “true” or “false”. |
| group(num1, num2, | Reduce the inclusive range of rule elements |
| label) | (num1, num2) and name the group node |
| | label. This reduce action this one may be |
| | repeated. |
| noop() | Perform no post action. This disables the |
| | default single() reduce action. |

TABLE XI
Post Actions for Printing Information.

| ACTION | DESCRIPTION |
|---|---|
| print(str) | Print the literal string str to standard output. |
| printr(num1, num2) | Print the text for the inclusive, rule-element |
| | range num1 to num2 to standard output. |
| prchild(file, num, name) | Look for named node immediately under the |
| | node matching the num-th rule element. Print |
| | its text to the named file, if found. |
| prtree(file, num, name) | Look for the named node anywhere under the |
| | node matching the num-th rule element. Print |
| | its text to the named file, if found. |
| prxtree(filename, | To the named file, print the first node named |
| presto, ord, name, poststr) | name found in the ord-th element's tree, |
| | preceded by the string prestr and followed by |
| | the string poststr. If the named node is not |
| | found, print nothing. For example: |
| | prxtree(“out.txt”, “date:”, 3, “_date”, “/n”) |
| | prints out a line like “date: 3/9/99 <cr>” if a |
| | _date node is found within the subtree of the |
| | third element. |
| prlit(file, str) | Print the literal string to the named file. |
| fprintnvar(file, var, ord) | To the named file, print the value of the |
| | variable var in the node of the ord-th element. |
| fprintxvar(file, var, ord) | To the named file, print the value of the |
| | variable var in the ord-th context node. |
| fprintgvar(file, var) | To the named file, print the value of the global |
| | variable var. |
| gdump(file) | Dump all global variables and their values to |
| | the named file. |
| xdump(file, ord) | Dump all variables in the ord-th context node |
| | and their values to the named file. |
| ndump(file, ord) | Dump all variables (and their values) in the |
| | node of the ord-th phrase element to the |
| | named file. |
| sdump(file) | Dump all variables in the suggested node and |
| | their values to the named file. |
| prrange(file, num1, num2) | Print the text under an inclusive range of rule |
| | elements (num1,num2) to the named file. |
| pranchor(file,num1,num2) | Print a web URL to the named file, treating the |
| | inclusive range (num1,num2) as a URL and |
| | using the global variable named “Base” to |
| | resolve and print complete relative URLs. (A |
| | prior pass may find the <base> HTML tag and |
| | set “Base” appropriately.) |

The invention supports the construction of text analyzers. Three example methods illustrate the capability supported by the invention.

The NLP++ language, when combined with the multi-pass methods of the invention, may invoke multiple text analyzers to analyze a single text. For example, a text analyzer to identify and characterize dates (e.g., “Jun. 30, 1999”) may be invoked by any number of other text analyzers to perform this specialized task. Text analyzers may invoke other text analyzers that are specialized for particular regions of text. For example, when the education zone of a resume is identified, a particular text analyzer for processing that type of zone may be invoked. Another way, as discussed above, is by means of the context-focusing methods supported by the NLP++ language.

A text analyzer may perform actions (such as spelling correction, part-of-speech tagging, syntactic pattern matching) only at a very high confidence level. If the confidence level is a user-specified parameter, a text analyzer may perform only the most confident (say, 100% confidence) actions first, then repeat the same cycle at a lower confidence level (say, 95%), and so on.

Such a scheme may be enhanced by building two kinds of text-analyzer passes. One type performs context-independent actions. The second type performs context-dependent actions. A text analyzer sequence then may perform actions more confidently based on context that has been determined by prior passes that have executed at higher confidence.

An illustrative instance of spelling correction is described. A context-independent spelling correction pass may be constructed with user-specified confidence. At the highest confidence, the system might correct “goign” to “going,” for example. A spelling correction pass may also be constructed that operates based on context. For example, any correction of the word “ot” without context is likely to be low confidence, but a pass that uses context can use patterns such as “going to” and other idioms of the language in order to correct patterns with high confidence. In the case of fabricated text such as “I am goign ot the store,” by executing high-confidence passes first, the text analyzer corrects this to “I am going ot the store.” Then, since a more meaningful context has been provided, a context-specific spelling correction pass can further correct this to “I am going to the store.”

Such a methodology applies to all aspects of text analysis, not just spelling correction. As higher confidence passes are executed, a parse tree may be constructed that enables pattern matching in context, thereby raising the confidence of subsequent passes.

The invention enables multiple-pass text analyzers to simulate the operation of a recursive grammar rule system (or parser). By controlling the sequence in which patterns and recursive rules are applied, such a method may yield a single and unambiguous parse tree. Grammar-rule systems typically yield large numbers of parse trees, even for short sentences.

Tight integration of the shell and the NLP++ language with a knowledge-base system enables a text analyzer to store and retrieve information obtained from processing multiple texts. NLP++ may interface to the knowledge base by means of pre-built functions. The shell may provide knowledge-base editors and dictionary editors so that developers of text analyzers can manipulate and manually view knowledge.

For example, in a chat between two bankers, each piece of the conversation is a separate text. During such a chat, the knowledge base may store the transaction as it has been agreed to at each point in the conversation.

The embodiments are by way of example and not limitation. Modifications to the invention as described will be readily apparent to one of ordinary skill in the art. For example, a single developer may use the invention as, for example a shell and method on a single machine. A group of developers may use the invention, each on a separate computer networked together.

This description of embodiments includes four appendices: Appendix I, “NLP++ Integration with a Knowledge Base,” Appendix II, “Rule File Analyzer,” Appendix III, “A BNF Grammar for an Instantiation of NLP++,” and Appendix IV, “The Confidence Operator According to One Embodiment.” Appendices I through IV are incorporated fully herein.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method for analyzing text in a natural language, the method comprising:
constructing a hierarchical tree representing a text in a natural language; and
applying a reduce rule to the hierarchical tree, the rule applicable only to an instance of a predetermined sub-hierarchy of the hierarchical tree.

2. The method of claim 1, wherein the step of applying comprises
specifying the predetermined sub-hierarchy as a path through the hierarchical tree.

3. The method of claim 2, wherein the step of applying further comprises
specifying the predetermined sub-hierarchy as a path through the hierarchical tree, the path a sequence of nodes starting at the root of the hierarchical tree.

4. The method of claim 2, wherein the step of applying further comprises
specifying the predetermined sub-hierarchy as a path through the hierarchical tree, the path a sequence of nodes starting at an instance of a node other than the root of the hierarchical free.

5. A method for constructing a text analyzer, the method comprising:
enabling a user to specify reduce rules for a hierarchical tree representing text in a natural language; and
enabling the user to specify a rule applicable only to an instance of a predetermined sub-hierarchy of the hierarchical tree.

6. A data store wherein is located a computer program for constructing a text analyzer by:
enabling a user to specify reduce rules for a hierarchical tree representing text in a natural language; and
enabling the user to specify a rule applicable only to an instance of a predetermined sub-hierarchy of the hierarchical tree.

7. A computer system for creating a text analyzer, the computer system comprising:
the data store of claim 6; and
a CPU, communicatively coupled to the data store and for executing the computer program in the data store.

8. A method for analyzing text in a natural language, the method comprising:
constructing a hierarchical tree representing a text in a natural language;
applying rules to nodes of the hierarchical tree to transform the tree, the rules having elements and suggested nodes; and
associating data with a node that matches an element of a rule.

9. A method for analyzing text in a natural language, the method comprising:
constructing a hierarchical tree representing a text in a natural language;
applying rules to nodes of the hierarchical tree to transform the tree, a rule having an element and a suggested node; and
associating data with a node that matches a suggested node of a rule.

10. A method for analyzing text in a natural language, the method comprising:
constructing a hierarchical tree representing a text in a natural language;
applying rules to nodes of the hierarchical tree to transform the tree, a rule having a context that is an instance of a predetermined sub-hierarchy of the hierarchical tree; and
associating data with a node that matches the context of a rule.
